(19) United States
(12) Patent Application Publication
(10) Pub. No.: US 2001/0051026 A1
(43) Pub. Date: Dec. 13, 2001

(54) Optical fiber ferrule made from dry etched parts

(76) Inventors: Dan A. Steinberg, Blacksburg, VA (US); David W. Sherrer, Blacksburg, VA (US)

Correspondence Address: HALEOS, INC., 3150 STATE STREET, BLACKSBURG, VA, 24060, US

(21) Appl. No.: 09/878,810

(22) Filed: Jun. 11, 2001

Related U.S. Application Data
(60) Provisional application No. 60/235,391, filed on Sep. 25, 2000.
(60) Provisional application No. 60/195,559, filed on Apr. 6, 2000.

(51) Int. Cl. G02B 6/36

(52) U.S. Cl. 385/78; 385/80

(57) ABSTRACT

A dry etched optical fiber ferrule includes two semicircular half-sections each bonded together by diametric edge portions having respective semicircular notches opposing one another, for providing a hole in receiving and being bond to a portion of an optical fiber.

### RELATED APPLICATIONS

The present Application is related to co-pending Provisional Application Ser. No. 60/235,391, filed Sep. 25, 2000, for “OPTICAL FIBER FERRULE MADE FROM DRY ETCHED PARTS”, from which the present Application claims priority. The teachings of Ser. No. 60/195,559 are incorporated herein by reference to the extent they do not conflict herewith. This Application is also related to co-pending Ser. No. 09/615,101, filed Jul. 13, 2000, for “2-DIMENSIONAL OPTICAL FIBER ARRAY MADE FROM ETCHED STICKS HAVING NOTCHES”.

### FIELD OF THE INVENTION

The present invention relates generally to devices for positioning optical fibers on substrates, and other carriers of optical fibers, and more particularly to ferrules for holding optical fibers in position on an object.

### BACKGROUND OF THE INVENTION

Optical fibers have extensive use for transmitting light, particularly light signals modulated to convey data or information, typically in digital form. The fibers are of extremely small diameter, and are fragile. Typically, optical fibers are coupled at one end to a light transmitting device, and at their other ends to light receiving devices. The ends of the fibers may also be coupled in end-to-end relationship with other mating fibers. In order to provide a reliable coupling and ensure high efficiency in the transfer of light or light signals, it is critical that the ends of the optical fibers be precisely aligned with the ends of other fibers or devices that they must be coupled to.

It is known in the art to use fiber ferrules to provide a mechanically robust mount for holding optical fibers in a desired position. Such fiber ferrules are typically made by cutting drawn glass tubes into ferrules of desired thickness with the through hole being of desired inside diameter. Optical fibers are passed through and retained in the holes of the ferrules. However, drawn glass ferrules are difficult to manufacture. Also, tolerances for multiple-fiber glass ferrules are difficult to maintain, causing low yield in the manufacture of such ferrules to given dimensions.

### SUMMARY OF THE INVENTION

It is an object of the present invention to provide ferrules for optical fibers that are economic to manufacture to desired tolerances.

Another object of the invention is to provide optical fiber ferrules that are easy to assemble for retaining optical fibers.

Another object of the invention is to provide optical fiber ferrules that are manufactured through use of dry etching.

With the problems of the prior art in mind, these and other objects of the invention are satisfied by using directional dry etching to produce optical fiber ferrule components of desired dimension and shape. In one embodiment of the invention the ferrule components are made in two one-half sections, each having a circumference of desired shape, each with a semicircular centrally located aperture in a diametric edge. The sections are formed by dry etching via RIE (Reactive Ion Etching). A complete ferrule component is made by bonding the two half pieces together, with the semicircular apertures opposing one another to form a centrally located hold therein, for later bonding to a portion of an optical fiber to be retained. Alternatively, the two half sections of the ferrule can be assembled onto a portion of an optical fiber, and bonded together, and to the optical fiber, for completing the assembly. In another embodiment of the invention, a plurality of the aforesaid ferrule components can be bonded together to provide an optical fiber ferrule of desired thickness. Also, in a third embodiment of the invention, the two half sections of an optical fiber component can be dry etched to include a plurality of spaced apart centrally located semicircular openings or grooves for retaining a plurality of optical fibers, thereby providing a multi-fiber ferrule. In a fourth embodiment of the invention, notches are etched into opposing circumferential portions of the ferrule sections for receiving alignment pins for more readily retaining the optical ferrules in a desired position with the associated optical fiber or fibers.

### BRIEF DESCRIPTION OF THE DRAWINGS

The various embodiments of the invention are described in detail below with reference to the drawings, in which like items are identified by the same reference designation, wherein:

FIG. 1 is an exploded pictorial assembly diagram showing two halves of an optical fiber ferrule being mounted together on a portion of an optical fiber, for one embodiment of the invention;

FIG. 2 is a perspective view showing the completed assembly of the optical fiber ferrule components and an optical fiber relative to FIG. 1;

FIG. 3 is a perspective view showing the stacking of a plurality of optical fiber ferrules on an optical fiber for effectively providing a thicker optical fiber ferrule for another embodiment of the invention;

FIG. 4 is a pictorial of an exploded assembly diagram showing a plurality of optical fiber components in the process of being bonded to an optical fiber, whereby the two half portions of each individual optical fiber component have been previously bonded to like half portions of other optical ferrule components, for providing a unitary optical fiber ferrule of desired thickness;

FIG. 5 shows a cross sectional view taken along 5-5 of FIG. 2;

FIG. 6 shows a cross sectional view taken along 6-6 of FIG. 3;

FIG. 7 shows a cross sectional view of the stacked optical fiber components of FIG. 6 mounted within a glass tube;

FIG. 8 shows a cross sectional view of two ferrule components each including two half sections mated together, with the ferrule sections joined by an etched stopped layer, with an optical fiber mounted therein, whereby each of the ferrule components were produced by dry etching from both sides of the associated wafers, for another embodiment of the invention;

FIG. 9 shows a pictorial of an exploded assembly view for another embodiment of the invention providing multi-fiber ferrules for retaining a plurality of optical fibers;

FIG. 10 shows the assembled multi-fiber optical ferrule with three optical fibers bonded thereto, relative to FIG. 9; and

FIG. 11 shows a front elevational view looking toward end faces of four optical fibers mounted within a multi-fiber ferrule of another embodiment of the invention, with notches being provided in the ferrule on opposing sides for receiving alignment pins, for another embodiment of the invention.

### DETAILED DESCRIPTION OF THE INVENTION

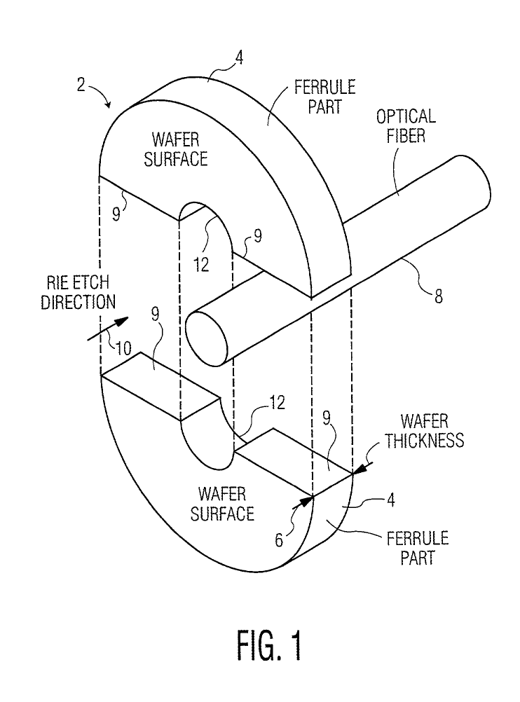

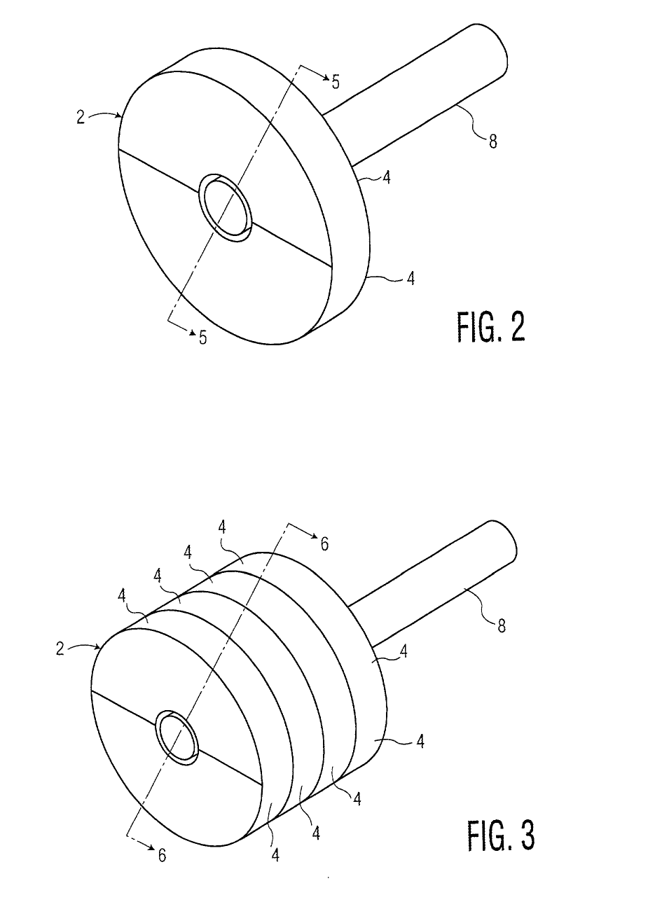

With reference to FIG. 1, in a first embodiment of the invention, each ferrule component 2 consists of two identical half sections 4, which for sake of simplicity of presentation are hereinafter referred to as ferrule parts 4. In the example given, each of the ferrule parts 4 is semicircular, and have a thickness ranging from about 0.2 millimeter to 2.0 millimeter. The ferrule parts 4 are produced by directional dry etching (e.g. using a deep etcher or a Bosch-like process). For example, the RIE etch direction is shown by arrow 10 in FIG. 1. The etched out semicircular central portions 12 are shaped and dimensioned to snuggly fit around an optical fiber 8 bonded within the semicircular grooves 12, with the two ferrule parts 4 being bonded to one another via diametric ledge portions 9. When so assembled, the ferrule component 2 bonded to an optical fiber 8 appears as shown in FIG. 2. Note that the optical fiber 8 and ferrule parts 4 can be bonded together using epoxy, sol-gel glass materials, or any other known bonding technique, including but not limited to aluminum thermo-compression bonding. The wafer thickness or thickness of each part 4 is limited by RIE etch processing. Also, note that silicon is the preferred material for the ferrule parts 4, and other ferrule parts for other embodiments of the invention as described below. However, any other suitable material can be used, provided it is RIE etchable. Note further that the diameter of the circular ferrule components 2 can typically range from 200 to 10,000 microns.

In all of the embodiments of the invention described herein, the associated ferrule components are shown to be circular about their circumference. However, the invention is not meant to be limited to circular ferrule components. In different applications, the outside shape of the ferrule component may not be circular. For example, the ferrule components may have a triangular shape, a square or rectangular shape, or any other practical circumferential shape. Also, for a particular ferrule component, the circumferential shapes of its two mated half-section ferrule parts may not have the same outer circumferential shape. Regardless, since optical fibers are typically circular in shape, the etched out central portions of the ferrule components are typically circular, and dimensioned to fit around an associated optical fiber.

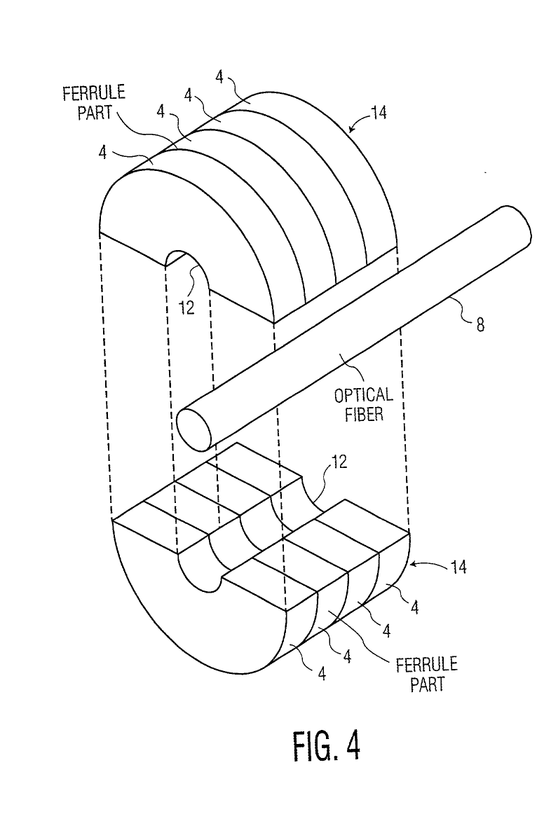

In another embodiment of the invention, as shown in FIG. 3, a thicker optical fiber ferrule 2 can be provided by stacking two or more pairs ferrule parts 4 together. As shown, the ferrule parts 4 can be bonded together prior to receiving and being bonded to the optical fiber 8, as previously described. Alternatively, the ferrule parts 4 and the optical fiber 8 can all be bonded together in a single step. For example, a plurality of the ferrule parts 4 can be bonded together to form two half-donut shaped ferrule parts 14, as shown in FIG. 4, before being bonded to the optical fiber 8. Another alternative is to bond all of the ferrule parts 4 together to form the stacked ferrule component 14, whereafter the optical fiber 8 is inserted through the etched out portions 12, and bonded to the ferrule parts 4.

As previously mentioned, the ferrule parts 4 are produced through use of RIE etching. This permits the shape and size of the ferrule parts 4 to be defined lithographically, which provides for very accurate dimensioning.

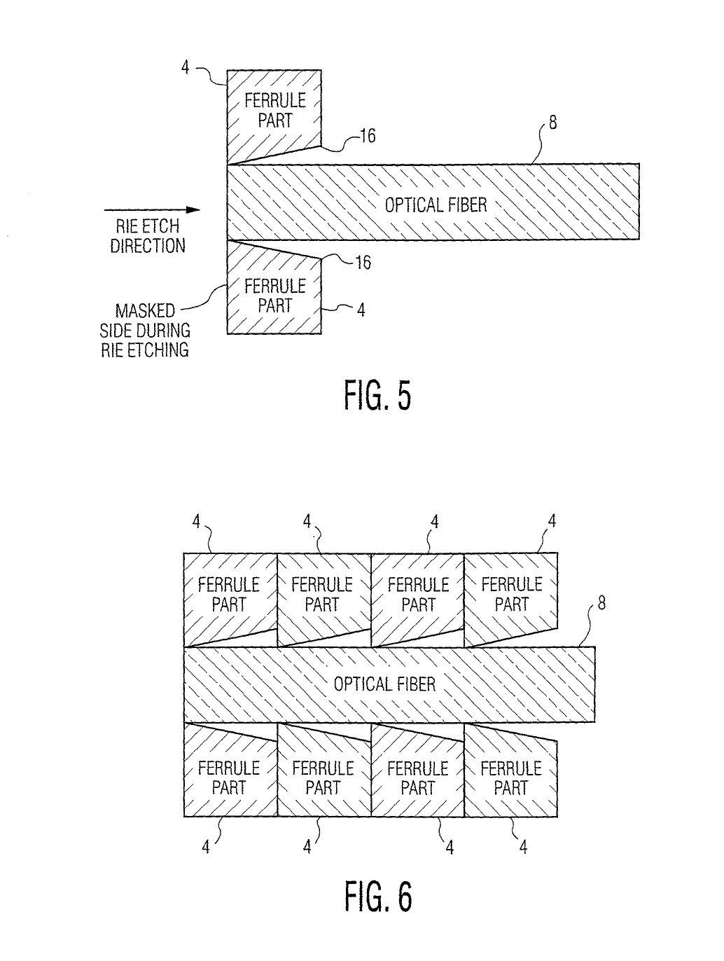

The face of the ferrule parts 4 that is intended to be flush with an optical fiber 8 endface, is preferably the face of the ferrule part 4 that is masked during RIE etching. The reason this is preferred is because the mask side typically has the most accurate dimensioning. Also, RIE etching usually produces a small amount of undercutting, causing the backside of the ferrule 4 to have a slightly larger bore 16 relative to the diameter at the masked side thereof, as shown in the cross sectional view of FIG. 5. This undercutting phenomena is also observed in the cross sectional view shown in FIG. 6 taken along 6-6 of the assembly of FIG. 3.

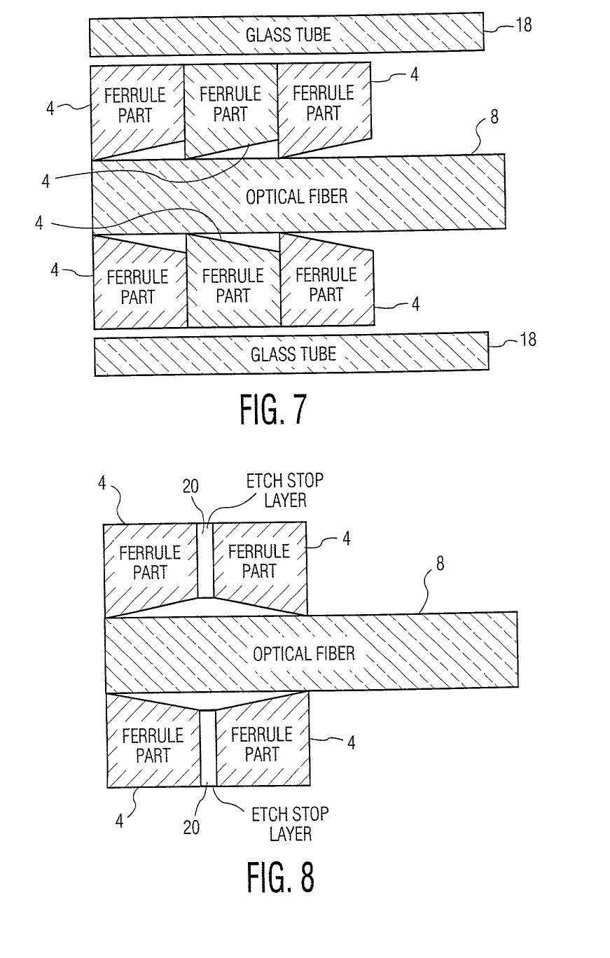

In another embodiment of the invention, the optical fiber 8 assembled within one or more pairs of ferrule parts 4, can in certain applications be installed within a glass tube 18. An example of such an assembly is shown in cross section in FIG. 7.

As previously indicated, the optical fiber ferrules formed from pairs of ferrule parts 4, as shown in the various embodiments of the invention, are applicable for use in a variety of fiber optic applications. Examples of these applications include, but are not limited to, waveguide couplers, fiber connectors, and so forth.

In yet another embodiment of the invention, as shown in the cross sectional view of FIG. 8, ferrule parts 4 are made by dry etching from both sides of a wafer having an etch stop layer 20 sandwiched therebetween. The etch stop layer can for example consist of SiO₂. As shown, this embodiment differs from the previous embodiments of the invention, in that the undercut portion of the ferrule parts 4 directly oppose one another relative to the longitudinal axes of the optical fiber 8, whereas in the other embodiments the masked faces or small bore faces of the ferrule parts 4 directly oppose the undercut larger bore face of the adjacent ferrule part 4.

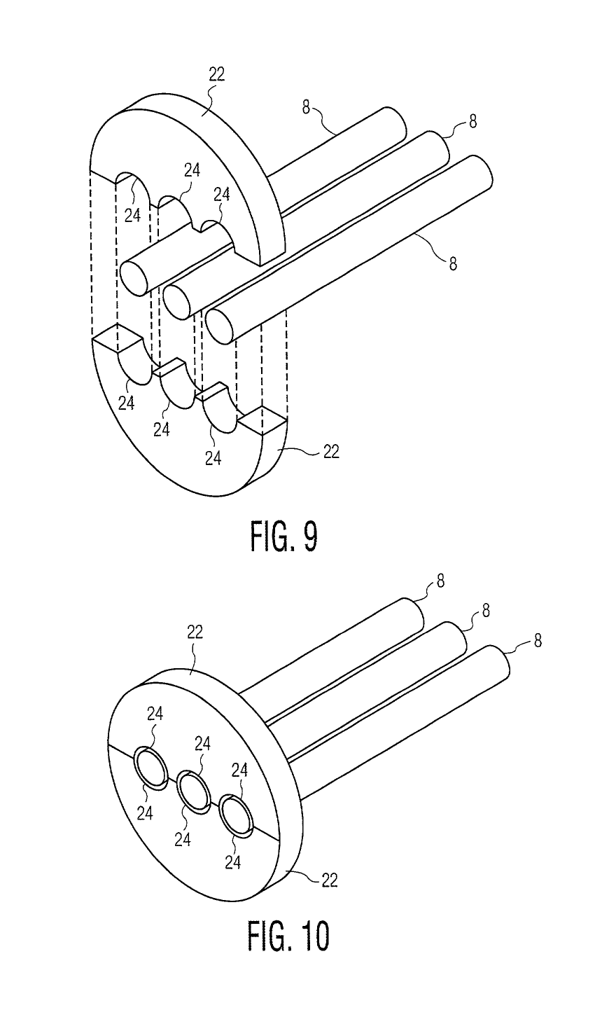

Another embodiment of the invention provides ferrule parts 22 each having a plurality of dry etched semicircular portions 24, as shown in the exploded assembly of FIG. 9. In the example shown, three semicircular etched out portions 24 are shown for each of the opposing two ferrule parts 22. When assembled together in FIG. 10, the opposing ferrule parts 22 are bonded together, and bonded to portions of three optical fibers 8, as shown.

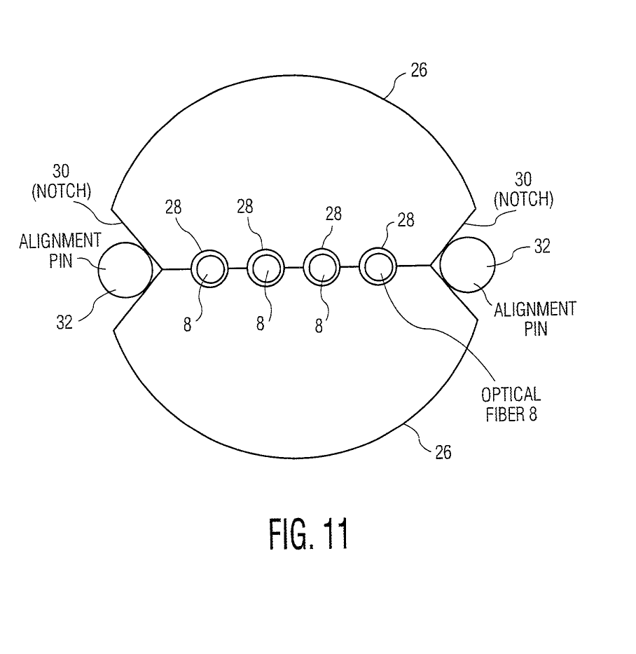

In each of the embodiments of the invention as described above for providing optical fiber ferrules, notches can be etched into opposing portions of the circumference of the optical fiber ferrules for permitting alignment pins to be utilized. In this optional embodiment of the invention, the alignment pins can function in a similar manner to the use of alignment pins in “MT” style fiber optic connectors. An example is shown in FIG. 11 of two ferrule parts 26 dry etched to provide when mated together, four centrally located spaced apart holes 28 for receiving and securely retaining four optical fibers 8, respectively. Notches 30 are formed on opposite sides of the ferrules 26, as shown, for receiving alignment pins 32. The notches are formed in the dry etched processing of the ferrule parts 26 through appropriate design of the etch mask applied to the front face of each of the ferrule parts 26. The notches 30 form alignment grooves that extend parallel with the optical fibers, in essentially the same manner as employed with MT-style connectors.

Note that in producing the optical fiber ferrules as described for each of the various embodiments of the invention, the etch mask used may or may not be removed, depending on the application. The mask can be a hard mask material, such as SiO₂, nitride, or metal. These materials are useful mask materials in a reactive ion etching process, as is known in the art. The mask in each embodiment is shaped to the same shape as the desired optical ferrule.

Although various embodiments of the invention have been shown and described, they are not meant to be limiting. Those of skill in the art may recognize various modifications to one or more of the embodiments, which modifications are meant to be covered by the spirit and scope of the appended claims. For example, with reference to FIGS. 9, 10, and 11, the optical fibers 8 can be arranged in other than a straight line, as shown. The optical fibers 8 can also be arranged in a zig-zag pattern or any other curvilinear shape that can be formed by the boundary between the two ferrule parts.

What is claimed is:

1. An optical fiber ferrule, comprising:
first and second one half sections, each having a circumference of desired shape, each having a diametric ledge portion adapted for mating with a like ledge portion of the other, a central portion of said ledge portion being formed into a semicircular notch dimensioned for receiving a portion of an optical fiber, and each being formed by RIE dry etching;
said first and second sections being bonded together via respective ledge portions, to complete said optical fiber ferrule.

2. An optical fiber ferrule, comprising:
first and second one half sections, each having a circumference of desired shape, each having a diametric ledge portion adapted for mating with a like ledge portion of the other, a central portion of said ledge portion being formed into a semicircular notch dimensioned for receiving a portion of an optical fiber, and each being formed by RIE dry etching;
said first and second sections being bonded together via respective ledge portions, to complete said optical fiber ferrule;
said first and second one-half sections when bonded together being configured to include alignment pin notches on opposing sides of their common circumferences, respectively.

3. An optical fiber ferrule, comprising:
first and second one half sections, each having a circumference of desired shape, each having a diametric ledge portion adapted for mating with a like ledge portion of the other, a central portion of said ledge portion being formed into a semicircular notch dimensioned for receiving a portion of an optical fiber, and each being formed by RIE dry etching;
said first and second sections being bonded together via respective ledge portions, to complete said optical fiber ferrule.

4. The optical fiber ferrule of claim 3, wherein said first and second one-half sections each consist of silicon.

5. The optical fiber ferrule of claim 3, wherein said first and second one-half sections each have a circular circumference.

6. The optical fiber ferrule of claim 3, wherein said first and second one-half sections are adapted for assembly to retain an optical fiber by either: (1) bonding the sections together, inserting an end of an optical fiber into the central hole of the joined sections and bonding the fiber to the first and second one-half sections, or (2) inserting an optical fiber into the notch of one of the sections, followed by mating the other section to the one section and said optical fiber, and bonding the same together.

7. The optical fiber ferrule of claim 3, further including:
a plurality of said first and second one-half sections, each having a front face, and a back face;
individual ones of said plurality of first and second one-half sections, respectively, being stacked and bonded together via opposing respective front and back faces, thereby forming a desired thicker pair of one-half sections than can be obtained from only one each of said first and second one-half sections;
said relatively thicker one-half sections of a plurality of first one-half sections, and a plurality of second one-half sections, being adapted for assembly to retain an optical fiber by either: (1) bonding the relatively thicker one-half sections together via respective ledge portions, followed by inserting an optical fiber into the central hole of the joined sections and bonding the fiber thereto, or (2) inserting an optical fiber into the notch of one of the thicker one-half sections, and bonding the other of the thicker one-half sections to the one thicker one-half section, via respective ledgers, and to said optical fiber also retained in the notch of the other thicker one-half section.

8. The optical fiber ferrule of claim 7, wherein each one of said plurality of said first and second one-half sections are formed by RIE dry etching.

9. The optical fiber ferrule of claim 7, wherein said plurality of said first and second one-half sections consist of silicon.

10. The optical fiber ferrule of claim 7, wherein said plurality of said first and second one-half sections each have a circular circumference.

11. The optical fiber ferrule of claim 3, further including:
said first and second one-half sections each including a pair of first and second ferrule parts each having outer and inner faces;
an etch stop layer sandwiched between the inner faces of said first and second ferrule parts, respectively;
each pair of said first and second ferrule parts with said etch stop layer being dry etched from their respective outer faces to produce said first and second one-half sections.

12. The optical fiber ferrule of claim 11, wherein each of said pairs of first and second ferrule parts consist of silicon.

13. The optical fiber ferrule of claim 12, wherein said etch stop layer consists of silicon dioxide.

14. The optical fiber ferrule of claim 11, wherein RIE etching is used to dry etch each pair of first and second ferrule parts.

15. The optical fiber ferrule of claim 11, wherein said first and second ferrule parts each have a circular circumference.

16. The optical fiber ferrule of claim 3, further including a plurality of spaced apart semicircular notches formed in said ledge portions of said first and second one-half sections, for receiving a like plurality of optical fibers, respectively.

17. The optical fiber ferrule of claim 16, wherein said first and second one-half sections are formed by RIE dry etching.

18. The optical fiber ferrule of claim 17, wherein said first and second on-half sections each consist of silicon.

19. The optical fiber ferrule of claim 16, wherein said first and second one-half sections each have a circular circumference.

20. The optical fiber ferrule of claim 7, wherein said plurality of thicker first and second one-half sections when bonded together further include alignment pin notches on opposing sides of their common circumferences.

21. The optical fiber ferrule of claim 11, wherein said first and second one-half sections when bonded together further include alignment pin notches on opposing sides of their common circumference.

22. The optical fiber ferrule of claim 16, wherein said first and second one-half sections when bonded together further include alignment pin notches on opposing sides of their common circumferences.
